(19) United States
(12) Patent Application Publication
(10) Pub. No.: US 2011/0047133 A1
(43) Pub. Date: Feb. 24, 2011

(54) Systems and Methods Involving Virtual Machine Images

(75) Inventors: Bowen L. Alpern, Hawthorne, NY (US); Glenn S. Ammons, Hawthorne, NY (US); Vasanth Bala, Hawthorne, NY (US); Todd W. Mummert, Hawthorne, NY (US); Darrell C. Reimer, Hawthorne, NY (US); Jian Yin, Bronx, NY (US); Xiaolan Zhang, Hawthorne, NY (US)

Correspondence Address: CANTOR COLBURN LLP-IBM YORKTOWN, 20 Church Street, 22nd Floor, Hartford, CT, 06103, US

(73) Assignee: Inaternational Business Machines Corporation, Armonk, NY (US)

(21) Appl. No.: 12/543,052

(22) Filed: Aug. 18, 2009

(51) Int. Cl. G06F 17/30

(52) U.S. Cl. 707/695; 707/E17.005; 707/E17.044; 707/E17.01

(57) ABSTRACT

A method comprises receiving a first virtual machine image, processing the first virtual machine image with a Mirage transformation, and generating a first manifest including a mapping of hierarchical names of content of the first virtual machine image to content identifiers.

### BACKGROUND

The present invention relates to virtual machine images, and more specifically, to managing and storing virtual machine images.

Virtual machine images are typically stored in filesystems that offer limited options for effectively managing large libraries of virtual machine images. A method and system for effectively and efficiently storing and managing virtual machine images is desired.

### BRIEF SUMMARY

According to one embodiment of the present invention, a method comprises receiving a first virtual machine image, processing the first virtual machine image with a Mirage transformation, and generating a first manifest including a mapping of hierarchical names of content of the first virtual machine image to content identifiers.

A system comprising a processor operative to receive a first virtual machine image, process the first virtual machine image with a Mirage transformation, and generate a first manifest including a mapping of hierarchical names of content of the first virtual machine image to content identifiers.

A computer program product including a computer readable medium having computer executable instructions embodied therewith that, as executed on a computer apparatus, implement a method comprises receiving a first virtual machine image, processing the first virtual machine image with a Mirage transformation, and generating a first manifest including a mapping of hierarchical names of content of the first virtual machine image to content identifiers.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram illustrating an example of a content addressable store.

FIG. 2 is a block diagram illustrating an example of a file version control system.

FIG. 3 is a block diagram illustrating an example of an ID token dictionary.

FIG. 4 illustrates an image version control (IVC) portion of an exemplary image version control system.

FIG. 5 illustrates an example of the logic used to check out an image from the IVC (of FIG. 4).

FIG. 6 illustrates an example of the logic for reconstituting an image in block 530 (of FIG. 5).

FIG. 7 illustrates an example of the logic for checking an image into the IVC (of FIG. 4).

FIG. 8 illustrates an exemplary method for indexing an image.

FIG. 9 illustrates an exemplary method for computing a delta by the IVC.

FIG. 10 illustrates an exemplary method for applying a delta to a manifest.

FIG. 11 illustrates an exemplary method for calculating a least common ancestor (LCA) of two images.

FIG. 12 illustrates an exemplary method for merging in the IVC.

FIGS. 13A and 13B illustrate an exemplary merge assist method.

FIG. 14 illustrates an exemplary method for resolving a delete conflict.

FIG. 15 illustrates an exemplary method for resolving an add conflict.

FIG. 16 illustrates an exemplary embodiment of a system for managing virtual machine images.

### DETAILED DESCRIPTION

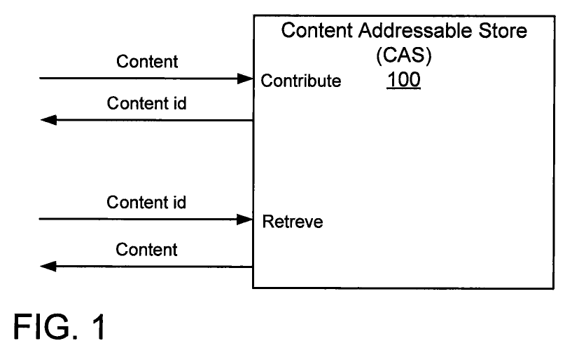

Virtual machine images are typically large files that use considerable storage space. One method for reducing the storage space used for virtual machine images includes Mirage transformations. Mirage transformation divides virtual machine images into units of data called shards. The shards are stored in a content addressable store (CAS) as shown in FIG. 1. A shard (content) that is contributed to the CAS 100 is associated with a content id (cid). A shard may be retrieved from the CAS 100 by presenting the associated cid. The Mirage transformation creates a unique manifest for each virtual machine image (image). The manifest includes a cid for each shard in an image, and includes information that allows the image to be constructed from the shards. Using Mirage transformations allows storage space to be reduced and provide a variety of version control options for users.

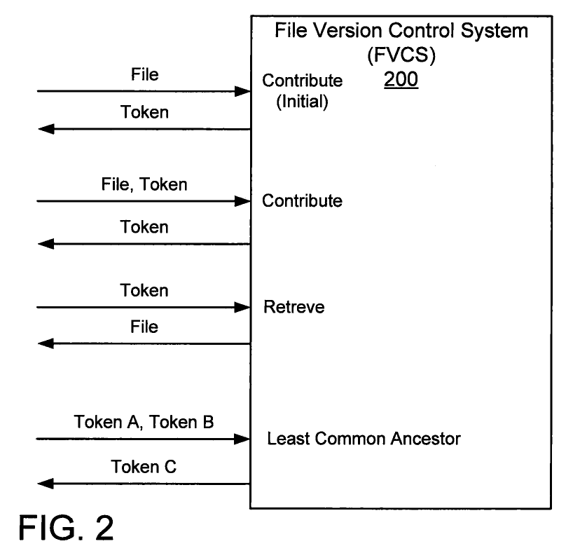

FIG. 2 illustrates a file version control system (FVCS) 200. The FVCS 200 associates tokens with file data. The tokens may be used to retrieve file data and to determine least common ancestors of two files in the system.

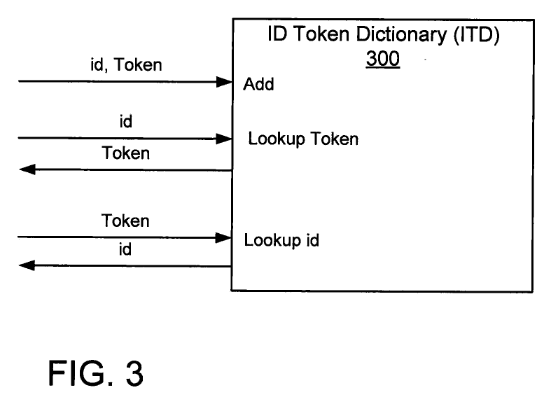

FIG. 3 illustrates an ID token dictionary (ITD) 300. The ITD 300 includes association data between tokens and ids. An inputted id or token returns the associated token or id respectfully.

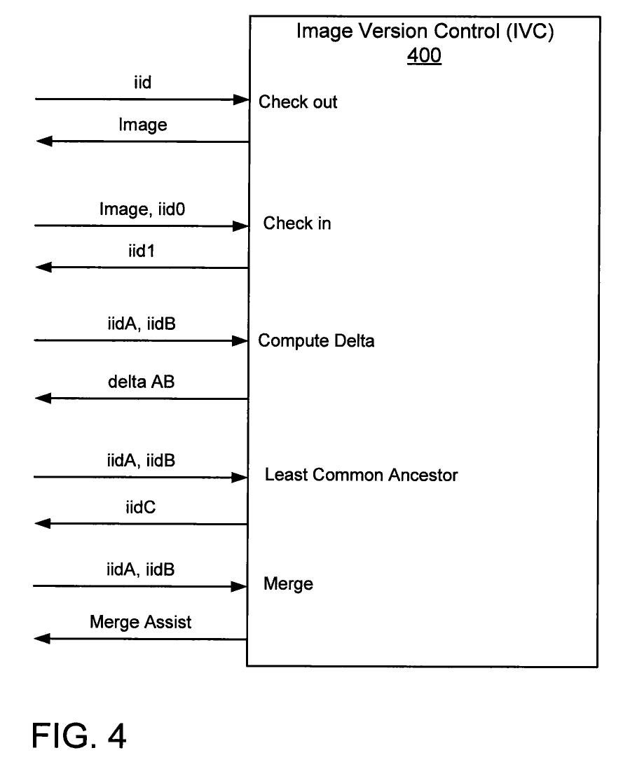

FIG. 4 illustrates an image version control (IVC) 400 portion of an image version control system. The IVC 400 is operative to check in and check out images, compute a difference between images, calculate a least common ancestor of images, and merge images.

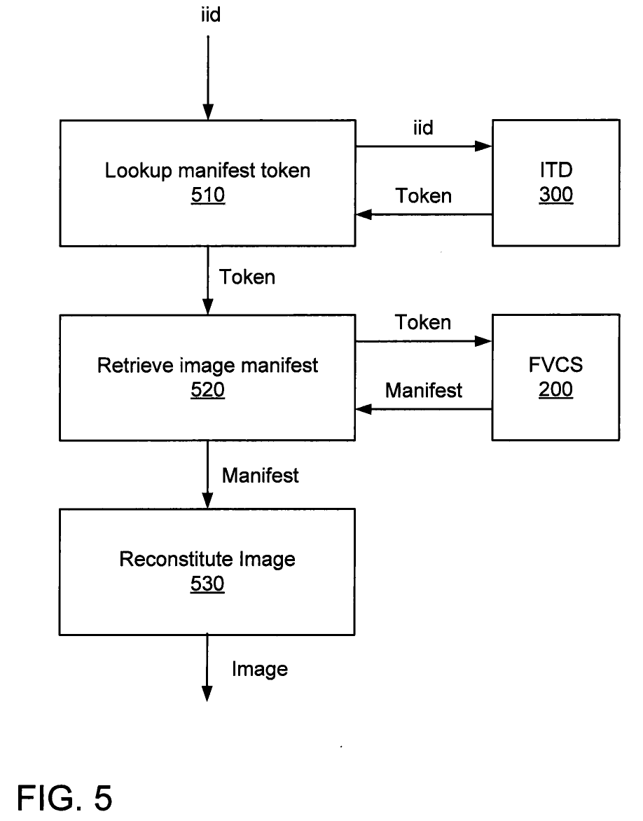

FIG. 5 illustrates an example of the logic used to check out an image from the IVC 400. In block 510, an image id (iid) is received, and the manifest token is retrieved from an ITD 300. In block 520, the token is used to retrieve the image manifest from an FVCS 200. In block 530, the image is reconstituted and output.

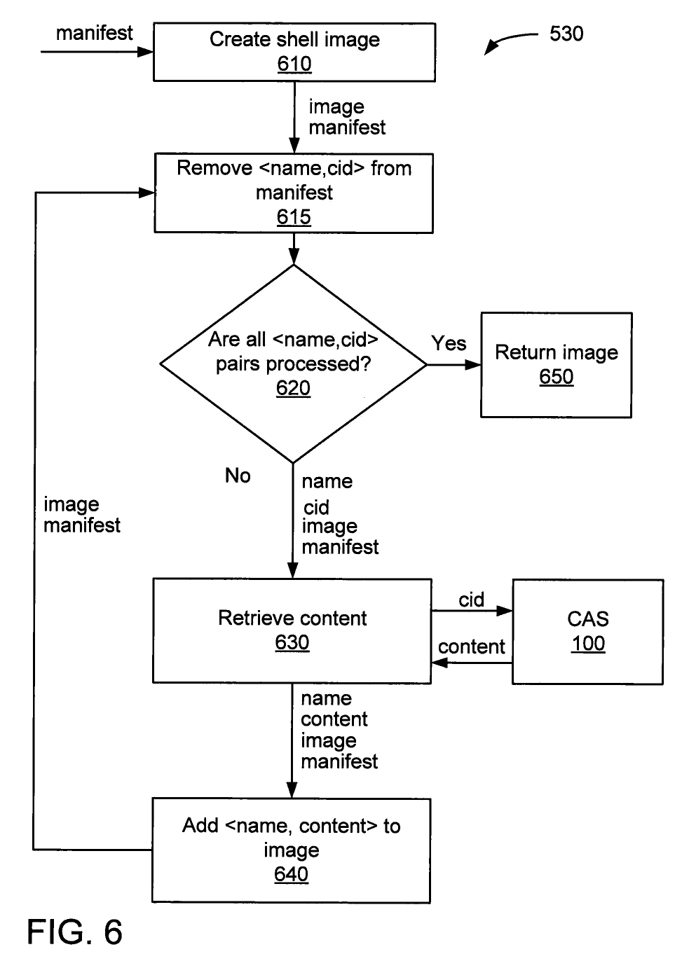

FIG. 6 illustrates an example of the logic for reconstituting an image in block 530 (of FIG. 5). In block 610 a manifest is received, and an empty shell image is created. In block 615, a first name-cid pair is removed from the manifest. In block 620, if all of the name-cid pairs have been processed, the reconstructed image is returned in block 650. If no, the content is retrieved in block 630 by sending the cid to the CAS 100. The name and content are added to the image in block 640.

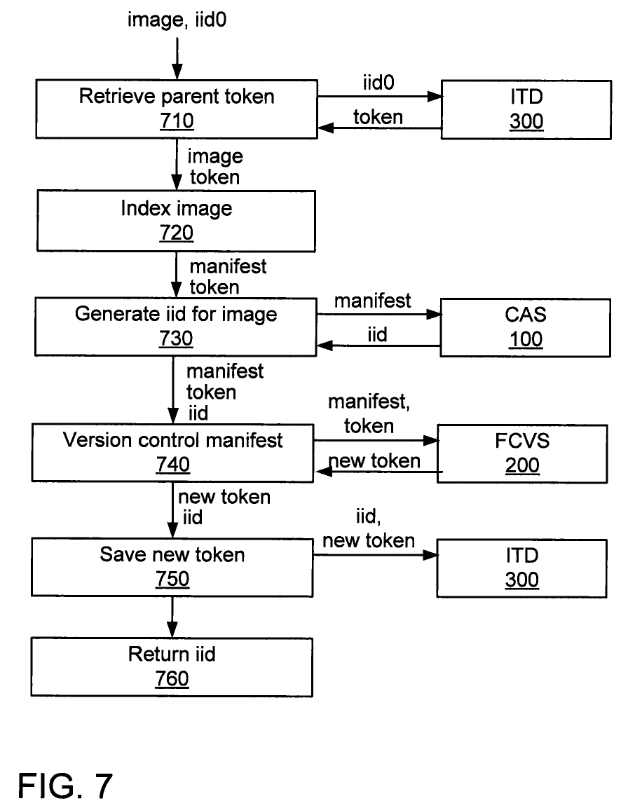

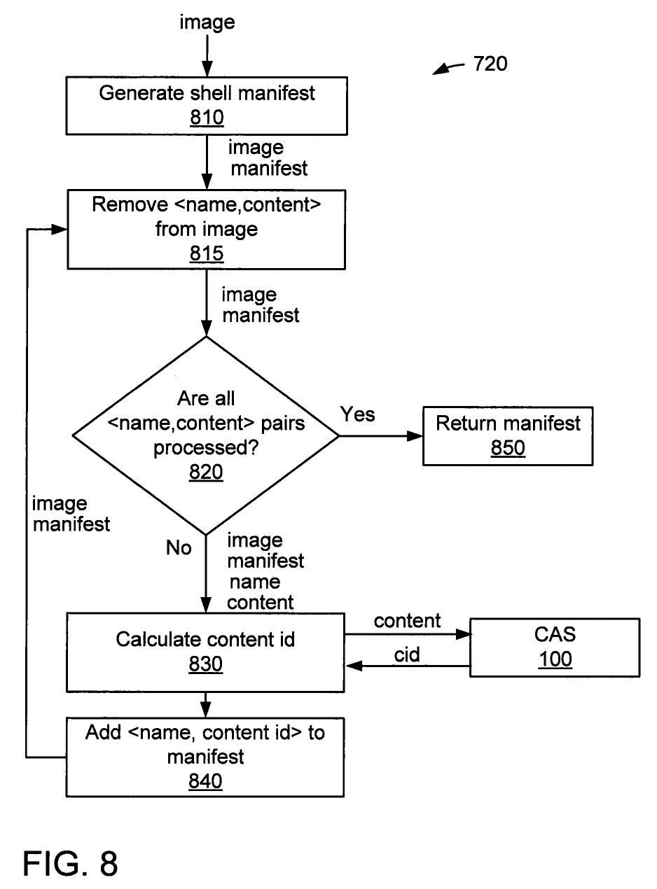

FIG. 7 illustrates an example of the logic for checking an image into the IVC 400 (of FIG. 4). An image and the image id of its parent imate, iid0, are received in block 710, and a token for the parent image is retrieved from the IID 300. In block 720, the imaged is indexed (detailed below in FIG. 8). An iid is generated for the image in block 730 using the CAS 100. The manifest and parent token are sent to the FCVS 200 in block 740, and a new token (for the incoming image) is received. In block 750, the new token and iid are saved in the ITD 300. The iid of the incoming image is returned in block 760.

FIG. 8 illustrates an exemplary method for indexing an image (as referenced above in block 720). In block 810 an image is received and an empty shell manifest is generated. In block 815, a first name-content pair is removed from the image. In block 820, if all of the name-content pairs are processed, the manifest is returned in block 850. If not, the content id is calculated in block 830 using the CAS 100. The name, content id is added to the manifest in block 840.

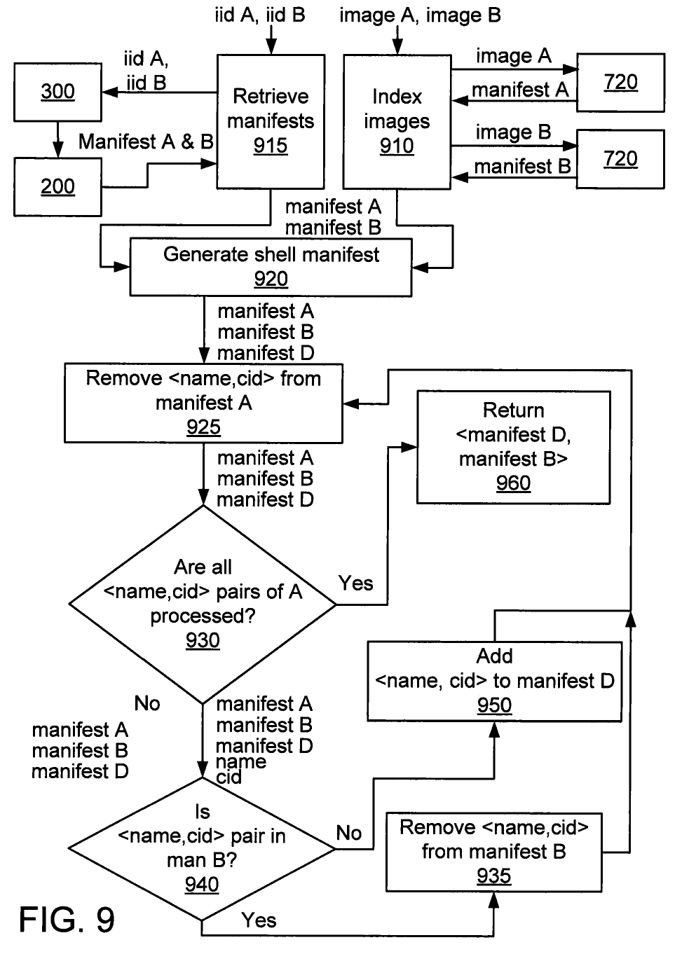

FIG. 9 illustrates an exemplary method for computing delta by the IVC 400. In block 910, image A and image B are received and indexed in blocks 720. Alternatively, iidA and iidB may be received in block 915 where they may be passed to IID 300 to return tokens. The tokens may be passed to IVCS 200 to retrieve the appropriate manifests. A shell manifest (manifest D) is generated in block 920. In block 925 a first name, cid pair is removed from the manifest A. If all of the pairs have been processed in block 930, the manifest D and manifest B are returned in block 960. If the name, cid pair is not in manifest B in block 940, the name, cid pair is added to the manifest D in block 950. If the name, cid pair is in manifest B, the name, cid pair is removed from manifest B in block 935.

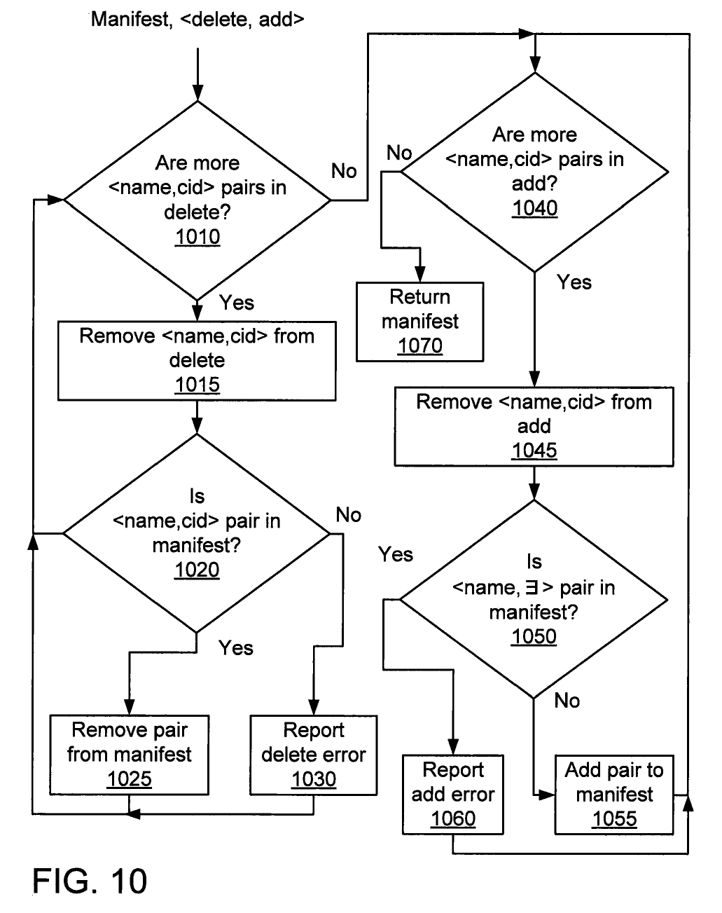

FIG. 10 illustrates an exemplary method for applying a delta manifest to a manifest. In block 1010 if name-cid pairs are in delete, the corresponding name-cid pair is removed from the delete in block 1015. In block 1020, if the name-cid pair is not present in the manifest, a delete error is reported in block 1030. In block 1010, if the remaining name-cid pairs have been deleted, the first name-cid pair is removed from the manifest in block 1025. If any name, cid pairs remain in the add field in block 1040, a name-cid pair is removed from the manifest in block 1045, if not the manifest is returned in block 1070. Block 1050 determines whether the name-data pair is present in the manifest. If yes, an add error is reported in block 1060, if no, the next name-data pair is added to the manifest in block 1055.

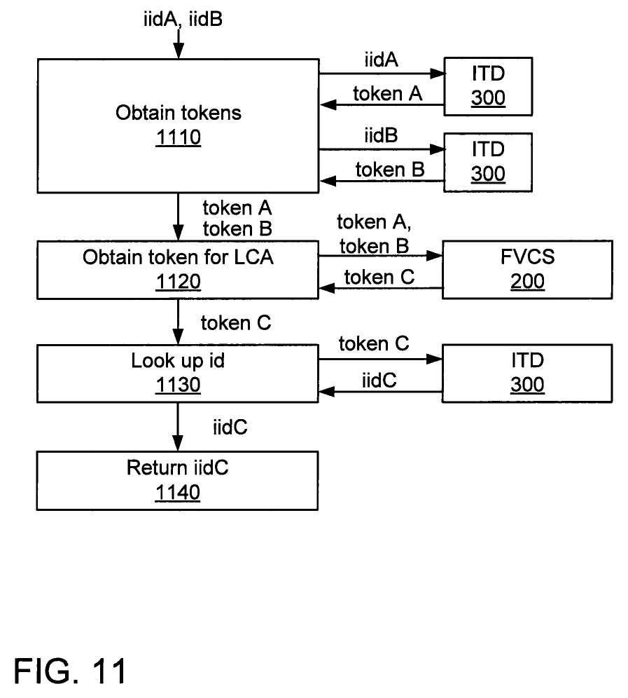

FIG. 11 illustrates an exemplary method for calculating a least common ancestor (LCA) of images. In block 1110 tokens are obtained for iidA and iidB using the ITD 300. The LCA token is obtained in block 1120 using FVCS 200. In block 1130 the id for the LCA token is obtained using ITD 300. The id of the LCA is returned in block 1140.

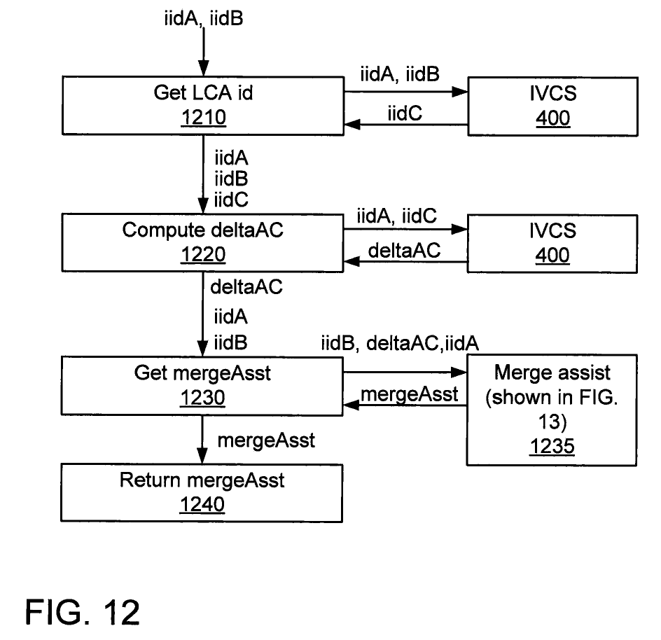

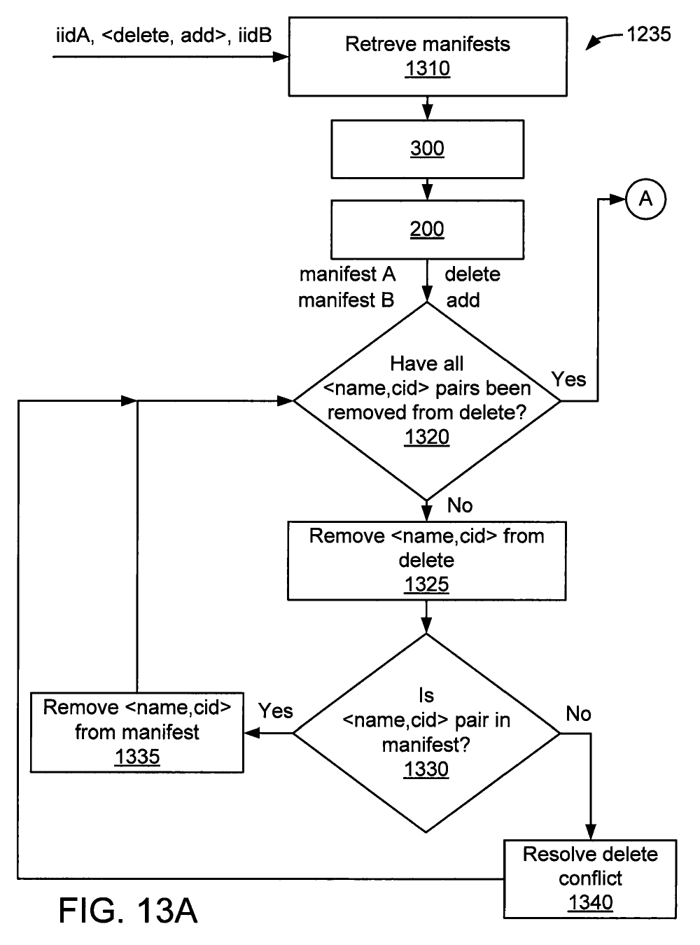

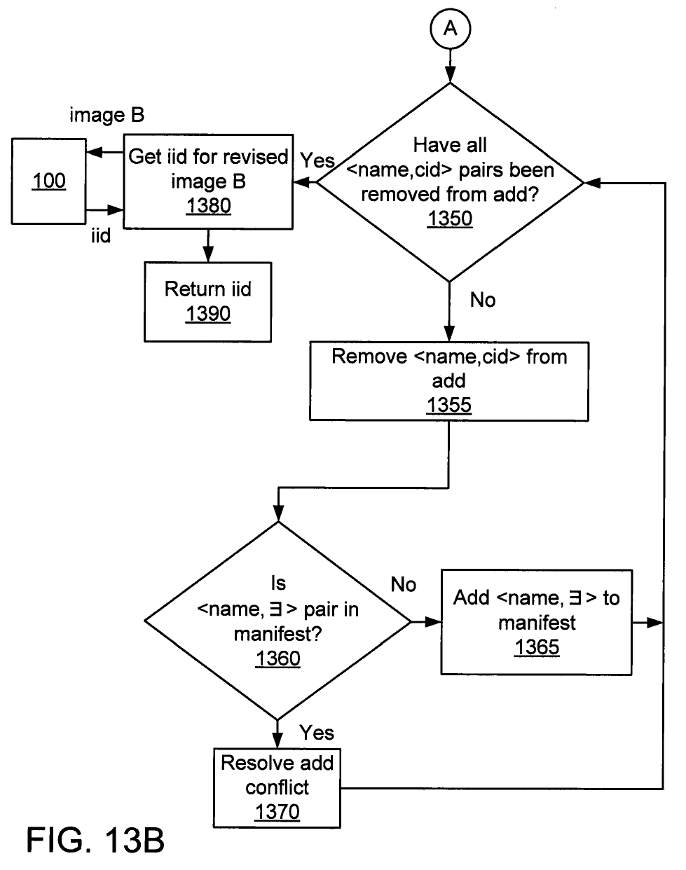

FIG. 12 illustrates an exemplary method for merging in the IVC 400. In block 1210, the LCA for the iids are calculated. The deltaAC is computed in block 1220. In block 1230, the mergeAssist is calculated using block 1235 (The details of the block 1235 are shown in FIGS. 13A and 13B.). The mergeAssist is returned in block 1240.

FIGS. 13A and 13B illustrate an exemplary merge assist method 1235. This mechanism does not magically resolve conflicting merges. Rather, it assists a human user to focus on the individual decisions that must be made in order to resolve the conflicts. In block 1310 a manifest is retrieved using the ITD 300 and the FVCS 200. Alternatively, the images may be indexed in a similar manner as described above in FIG. 9. If all name-cid pairs have not been removed from delete in block 1320, a name-cid pair is removed from the delete field in block 1325. Block 1330 determines whether the name-cid pair is present in the manifest, if not, the delete conflict may be resolved by a user in block 1340. In block 1335, the name-cid pair is removed from the manifest. Referring to FIG. 13B, if all name-cid pairs have been removed from add in block 1350, the iid for the revised image B is retrieved in block 1380 using the CAS 100, and the iid is returned in block 1390. If not, the name-cid pair is removed from the add in block 1355. In block 1360, if a name-data pair is present in the manifest, the add conflict may be resolved by a user in block 1370. If a name-data pair is not present in the manifest the name-data pair is added to the manifest in block 1365. In the illustrated embodiment, the cid of a manifest of an image is the iid of the image, however other embodiments may use other methods for assigning iids.

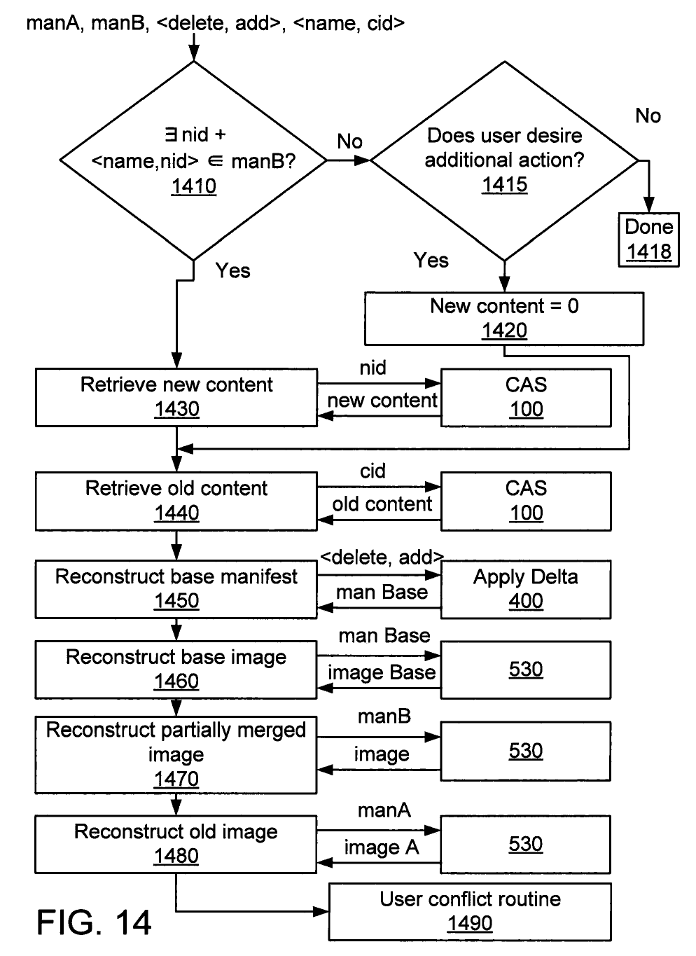

FIG. 14 illustrates an exemplary method for resolving a delete conflict. In block 1410, if a name-nid pair is not present in the manifest, the user may be queried in block 1415 to determine whether the user desires additional action. If no, the routine may end in block 1418. If yes, new shell content is generated in block 1420. In block 1430 new content is retrieved using the CAS 100. In block 1440, old content is retrieved using the CAS 100. In block 1450, the base manifest may be reconstructed by applying the incoming delta. A partially merged image may be reconstructed in block 1470 using block 530 (of FIG. 5). In block 1480, an old image may be reconstructed using block 530. In block 1490, a user conflict routine may be used by a user to manually or semi-manually resolving a delete conflict.

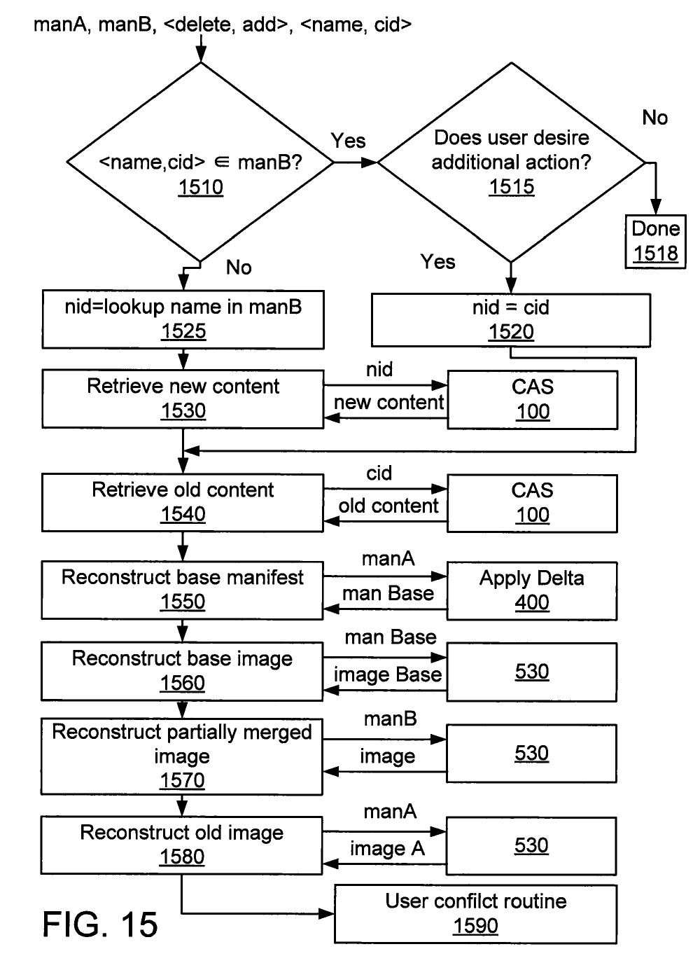

FIG. 15 illustrates an exemplary method for resolving an add conflict. If the name-cid pair is present in the manifest in block 1510, the user may be queried to determine if the user desires additional action in block 1515. If no the routine may end in block 1518. If the query in block 1510 is no, the nid is set equal to the cid in block 1520. In block 1525, the nid is set to equal the lookup of the name in the manifest B. New content is retrieved in block 1530 using CAS 100. In block 1540, the old content may be retrieved using the CAS 100. In block 1550 the base manifest may be reconstructed by applying delta. The base image may be reconstructed in block 1560 using block 530 (of FIG. 5). In block 1570, the partially merged image may be reconstructed using block 530. The old image may be reconstructed in block 1580 using block 530. In block 1590, a user conflict routine may be used by a user to manually or semi-manually resolve an add conflict.

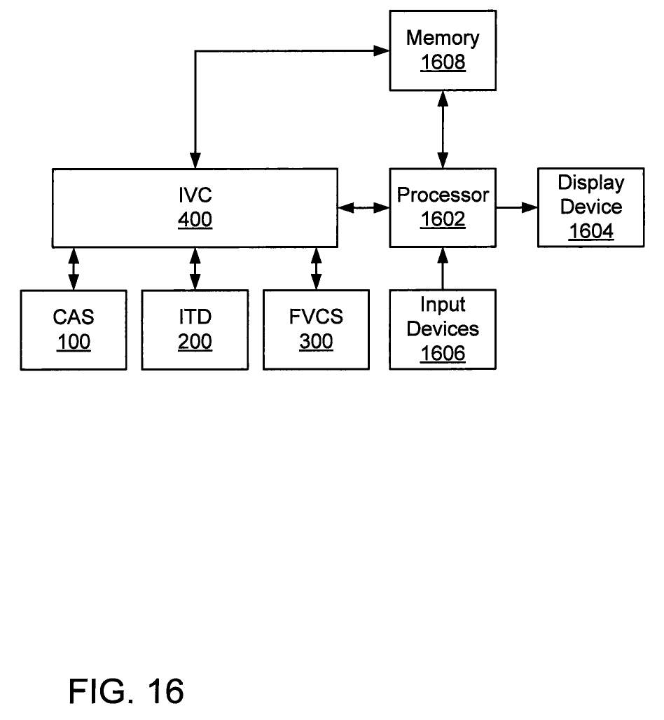

FIG. 16 illustrates an exemplary embodiment of a system operative to perform the logic functions described above. The system includes a processor 1602 communicatively connected to a display device 1604, input devices 1606, and a memory 1608. The IVC 400 is communicatively connected to the processor 1602, the memory 1608, the CAS 100, the ITD 200, and the FVCS 300. One skilled in the art understands that the IVC 400 may reside in the processor 1602 or may be present on another processor such as, for example, a server.

The exemplary embodiments described above use a file version control system to preserve the relationship between images using manifests as image surrogates. Other embodiments may use other types of version control systems that may, for example, use iids or other similar identifiers as image surrogates. The merge algorithm in the exemplary embodiment is an illustrative example other merge algorithms including those developed to perform three-way merges of files and/or file systems may be adapted to be used in a similar manner as described above.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

Example embodiments of the present invention may be implemented, in software, for example, as any suitable computer program. For example, a program in accordance with one or more example embodiments of the present invention may be a computer program product causing a computer to execute one or more of the example methods described herein: a method for simulating arbitrary software and/or unmodified code directly on a host processor.

The computer program product may include a computer-readable medium having computer program logic or code portions embodied thereon for enabling a processor of the apparatus to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

These programs may also be provided in the form of an externally supplied propagated signal and/or a computer data signal (e.g., wireless or terrestrial) embodied in a carrier wave. The computer data signal embodying one or more instructions or functions of an example methodology may be carried on a carrier wave for transmission and/or reception by an entity that executes the instructions or functions of the example methodology. For example, the functions or instructions of the example embodiments may be implemented by processing one or more code segments of the carrier wave, for example, in a computer, where instructions or functions may be executed for simulating arbitrary software and/or unmodified code directly on a host processor, in accordance with example embodiments of the present invention.

Further, such programs, when recorded on computer-readable storage media, may be readily stored and distributed. The storage medium, as it is read by a computer, may enable the simulation of arbitrary software and/or unmodified code directly on a host processor, in accordance with the example embodiments of the present invention.

Example embodiments of the present invention being thus described, it will be obvious that the same may be varied in many ways. For example, the methods according to example embodiments of the present invention may be implemented in hardware and/or software. The hardware/software implementations may include a combination of processor(s) and article(s) of manufacture. The article(s) of manufacture may further include storage media and executable computer program(s), for example, a computer program product stored on a computer readable medium.

The executable computer program(s) may include the instructions to perform the described operations or functions. The computer executable program(s) may also be provided as part of externally supplied propagated signal(s). Such variations are not to be regarded as departure from the spirit and scope of the example embodiments of the present invention, and all such modifications as would be obvious to one skilled in the art are intended to be included within the scope of the following claims.

Although example embodiments of the present invention have been discussed herein with regard to specific applications and/or implementations, it will be understood that example embodiments may be utilized in, for example, in firm ASIC chip design or implemented in traditional circuitry.

Although example embodiments of the present invention have been shown and described with regard to certain operations (e.g., S114, S116, and/or S118 of FIG. 2) being performed serially or consecutively, it will be understood that any combination of these operations may be performed simultaneously and in parallel.

Although specific aspects may be associated with specific example embodiments of the present invention, as described herein, it will be understood that the aspects of the example embodiments, as described herein, may be combined in any suitable manner.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method comprising:
receiving a first virtual machine image;
processing the first virtual machine image with a Mirage transformation; and
generating a first manifest including a mapping of hierarchical names of content of the first virtual machine image to content identifiers.

2. The method of claim 1, wherein the method further comprises outputting an image identifier associated with the first manifest.

3. The method of claim 1, wherein the method further comprises computing a difference between the first manifest and a second manifest, wherein the difference includes a delete list of hierarchical name and content identifier pairs that are not present in the first manifest and present in the second manifest.

4. The method of claim 3, wherein the difference includes an add list of hierarchical name and content identifier pairs that are present in the first manifest and not present in the second manifest.

5. The method of claim 1, wherein the method further comprises generating a least common ancestor manifest of the first virtual machine image and a second virtual machine image.

6. The method of claim 1, wherein the method further comprises merging the first virtual machine image with a second virtual machine image.

7. A system comprising a processor operative to receive a first virtual machine image, process the first virtual machine image with a Mirage transformation, and generate a first manifest including a mapping of hierarchical names of content of the first virtual machine image to content identifiers.

8. The system of claim 7, wherein the processor is further operative to output an image identifier associated with the first manifest.

9. The system of claim 7, wherein the processor is further operative to compute a difference between the first manifest and a second manifest, wherein the difference includes a delete list of hierarchical name and content identifier pairs that are not present in the first manifest and present in the second manifest.

10. The system of claim 9, wherein the difference includes an add list of hierarchical name and content identifier pairs that are present in the first manifest and not present in the second manifest.

11. The system of claim 7, wherein the processor is further operative to generate a least common ancestor manifest of the first virtual machine image and a second virtual machine image.

12. The system of claim 7, wherein the processor is further operative to merging the first virtual machine image with a second virtual machine image.

13. A computer program product including a computer readable medium having computer executable instructions embodied therewith that, as executed on a computer apparatus, implement a method comprising:
receiving a first virtual machine image;
processing the first virtual machine image with a mirage transformation; and
generating a first manifest including a mapping of hierarchical names of content of the first virtual machine image to content identifiers.

14. The computer program product of claim 13, wherein the method further comprises outputting an image identifier associated with the first manifest.

15. The computer program product of claim 13, wherein the method further comprises computing a difference between the first manifest and a second manifest, wherein the difference includes a delete list of hierarchical name and content identifier pairs that are not present in the first manifest and present in the second manifest.

16. The computer program product of claim 15, wherein the difference includes an add list of hierarchical name and content identifier pairs that are present in the first manifest and not present in the second manifest.

17. The computer program product of claim 13, wherein the method further comprises generating a least common ancestor manifest of the first virtual machine image and a second virtual machine image.

18. The computer program product of claim 13, wherein the method further comprises merging the first virtual machine image with a second virtual machine image.
